(19) United States
(12) Patent Application Publication
(10) Pub. No.: US 2008/0222666 A1
(43) Pub. Date: Sep. 11, 2008

(54) OPTICAL DISC PLAYER

(75) Inventors: Sang In LEE, Anyang-si (KR); Ju Won Cho, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/038,080

(22) Filed: Feb. 27, 2008

(30) Foreign Application Priority Data
Mar. 6, 2007 (KR) 2007-21979

(51) Int. Cl. G11B 33/02

(52) U.S. Cl. 720/647

(57) ABSTRACT

An optical disc player capable of keeping a rear surface of a door out of a user's sight when the door is opened to present an aesthetically pleasing appearance and promote a beauty thereof. The optical disc player includes a main body with a front panel having an entrance, a tray disposed at the main body to be extracted from or retracted into the main body through the entrance, a door to open or close the entrance, and a door connecting unit to connect the door to the front panel such that the door is opened or closed. The door connecting unit includes a first connecting link having one end rotatably connected to a first position of an inner surface of the door and the other end rotatably connected to a second position of the front panel, and a second connecting link having one end rotatably connected to a third position higher than the first position of the inner surface of the door and the other end rotatably connected to a fourth position higher than the second position of the front panel.

### CROSS-REFERENCE TO RELATED APPLICATIONS

This application claims the benefit under 35 U.S.C. 119(a) of Korean Patent Application No. 2007-0021979, filed on Mar. 6, 2007 in the Korean Intellectual Property Office, the disclosure of which is incorporated in its entirety.

### BACKGROUND OF THE INVENTION

1. Field of the Invention

The present general inventive concept relates to an optical disc player, and more particularly to an optical disc player having a door capable of opening and closing a front entrance.

2. Description of the Related Art

An optical disc player is a device for recording information on mass storage media such as a compact disc (CD), a digital video disc (DVD) and a blu-ray disc or reproduces the recorded information from the mass storage media in a play back mode.

Generally, the optical disc player includes a turn table for rotating an optical disc, an optical pick-up device for reading or writing information to/from the disc, and a tray for loading or unloading the optical disc through a front entrance. The optical disc player further includes a door for opening and closing the front entrance. The door can prevent dust or foreign substances from entering into the optical disc player as well as promote the beauty of a front surface of the optical disc player by closing the entrance.

Korean Patent Laid-open Publication No. 2006-21515 discloses a door device of an optical disc player. The door device includes a door for opening or closing an entrance of the optical disc player, a door arm for rotatably supporting the door and a torsion spring coupled to a hinge pin of the door arm. In the door device, when a tray is extracted from a main body of the optical disc player through the entrance, the door is opened while being pushed and rotated by the tray. Alternatively, when the tray is retracted into the main body, the door is closed while being inversely rotated by the elasticity of the torsion spring.

However, since the door is opened while being rotated around the hinge pin in the optical disc player, a rear surface of the opened door is exposed to a user, thereby degrading the beauty. Particularly, since the rear surface of the door is not coated for the sake of cost reduction, exposure of the rear surface of the door may spoil its appearance and degrade the beauty.

### SUMMARY OF THE INVENTION

The present general inventive concept has been made in order to solve the above problems by providing an optical disc player capable of keeping a rear surface of a door out of a user's sight, thereby presenting an aesthetically pleasing appearance and promoting the beauty thereof.

Additional aspects and utilities of the present general inventive concept will be set forth in part in the description which follows and, in part, will be obvious from the description, or may be learned by practice of the general inventive concept.

The present general inventive concept provides an optical disc player having a main body including a front panel with an entrance, a tray disposed at the main body to be extracted from or retracted into the main body through the entrance, a door to open or close the entrance, and a door connecting unit to connect the door to the front panel such that the door is opened or closed. The door connecting unit includes a first connecting link having one end rotatably connected to a first position of an inner surface of the door and the other end rotatably connected to a second position of the front panel, and a second connecting link having one end rotatably connected to a third position being situated higher than the first position on the inner surface of the door and the other end rotatably connected to a fourth position being situated higher than the second position located on the front panel.

The first connecting link and the second connecting link may be respectively connected to the second position and the fourth position located below the entrance on an inner surface of the front panel.

At least one of the first connecting link and the second connecting link may be bent into a “C” shape to prevent interference with a lower end of the entrance while the door is opened.

At least one of the first connecting link and the second connecting link may include a contact rib which may be pushed by the tray when the tray is extracted from the main body.

A distance between the first position and the second position may be equal to a distance between the third position and the fourth position.

The optical disc player may also include rotational shafts respectively provided at the first to fourth positions to rotatably connect opposing ends of the first connecting link and the second connecting link with the first to fourth positions.

The optical disc player may also include a closing spring installed on at least one of the first connecting link and the second connecting link to pull the door to be closed when the tray retracts into the main body.

Each one of the first and second connecting links may include a pair of members respectively disposed at opposing sides of the inner surface of the door, and the door connecting unit may further include a first stiffening member to connect the members of the first connecting link disposed at opposing sides of the door with each other and a second stiffening member to connect the members of the second connecting link being disposed at opposing sides of the door with each other.

The foregoing and/or other aspects and utilities of the present general inventive concept may also be achieved by providing an optical disc player including a main body with a front panel having an entrance, a tray installed at the main body to be extracted from or retracted into the main body through the entrance, a door to open or close the entrance, and a door connecting unit to connect the door to the front panel such that the door is opened and closed. The door connecting unit may include a first connecting link and a second connecting link to form a four-joint link, each link having opposite ends rotatably connected to the door and an inner surface of the front panel such that the door is opened or closed by movements.

The foregoing and/or other aspects and utilities of the present general inventive concept may also be achieved by providing an optical disc player having a moveable door to secure an entrance formed in a font panel of the optical disc player including a first arc shaped door connecting unit having a first end rotatably coupled to an inner surface of the door and a second end rotatably coupled to an inner surface of the front panel. The door connecting unit rotates in a first direction to move the door to a first position shifted from the entrance and rotates in a second direction to move the door to a second position to a side covering the entrance.

The optical disc player may also include a second arc shaped door connecting unit located above the first door connecting unit and having a first end rotatably coupled to an inner surface of the door and a second end rotatably coupled to an inner surface of the front panel.

The pair of connecting links may include a pair of protrusions extending from a rear surface thereof to contact a tray unit as the tray unit is extracted from the main body of the optical disc player.

The foregoing and/or aspects and utilities of the present general inventive concept may also be achieved by providing an optical disc player with a front panel and a main entrance formed thereon including a tray unit to reciprocatingly move in a linear direction from the main entrance of the optical disc player and an adjustable door unit being coupled to the front panel and to rotate in a non-linear direction via the reciprocating movement of the tray unit.

The door unit may include a door to secure the entrance of the optical disc player, a pair of first connecting links being separated by a first stiffening member, and a pair of second connecting links being separated by a second stiffening member. The first pair of connecting links and the second pair of connecting links may simultaneously rotate about a pair of first rotational shafts and a pair of second rotational shafts, respectively.

The first pair of rotational shafts may be located at opposing ends of the pair of first connecting links and the second pair of rotational shafts are located at opposing ends of the pair of second connecting links.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 illustrates a view of a front portion of an optical disc player according to the present general inventive concept;

FIG. 2 illustrates an enlarged view of a door and a door connecting unit of the optical disc player according to the present general inventive concept;

FIG. 3 illustrates a cross-sectional view of the door and the door connecting unit when the door is closed in the optical disc player according to the present general inventive concept; and

FIG. 4 illustrates a cross-sectional view of the door and the door connecting unit when the door is opened in the optical disc player according to the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below in order to explain the present general inventive concept by referring to the figures.

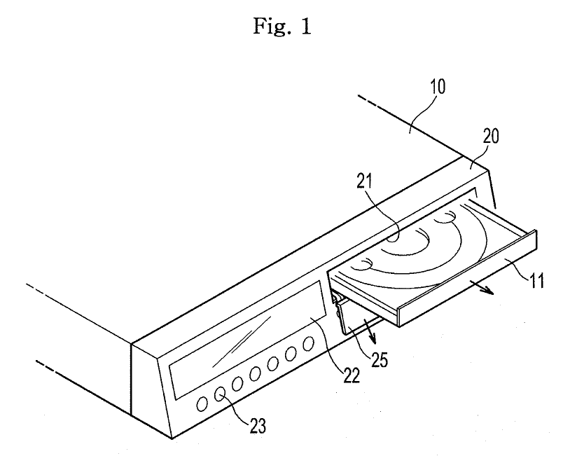

As illustrated in FIG. 1, an optical disc player according to the present general inventive concept includes a main body 10 and a front panel 20 mounted on a front surface of the main body 10. An entrance 21 is formed at one side of the front panel 20 such that a tray to load an optical disc is extracted from and/or retracted into the main body 10 through the entrance 21. A display section 22 to display an operation state of the optical disc player and operation buttons 23 to control an operation of the optical disc player are both disposed at the other side of the front panel 20, with respect to the entrance.

Although not illustrated in the drawings, the main body 10 includes a tray driving unit to drive a tray 11 to be extracted from and/or retracted into the main body 10, a spindle motor to rotate the optical disc, a loading unit to couple the optical disc loaded into the main body 10 to the spindle motor or to separate the optical disc from the spindle motor, and an optical pick-up device to read information recorded on the optical disc and/or write new information on the optical disc.

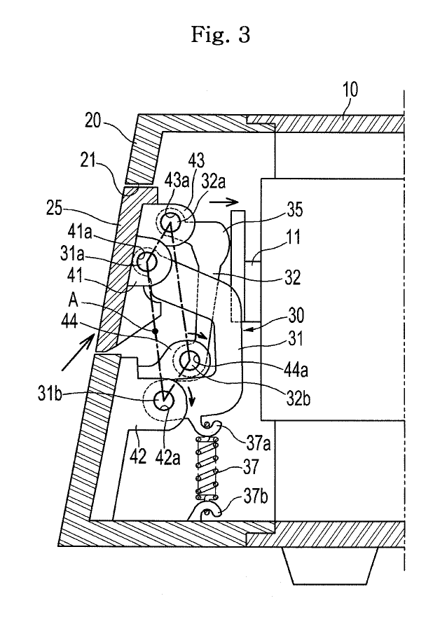

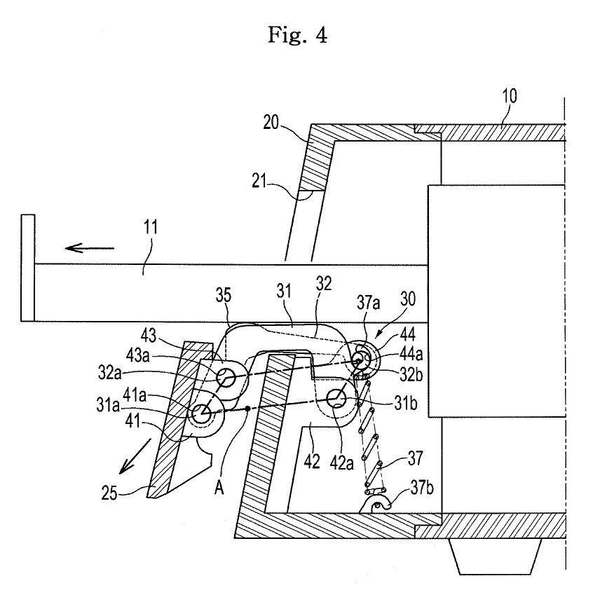

As illustrated in FIGS. 1, 3 and 4, a door 25 is disposed on the front surface of the front panel 20 to open or close the entrance 21. As illustrated in FIG. 3, when the tray 11 is retracted into the main body 10, the door 25 is closed. As illustrated in FIG. 4, when the tray 11 is extracted from the main body 10, the door 25 is opened and moved to a lower front side of the optical disc player while being pushed by the tray 11. A door connecting unit 30 is installed on both the inner surfaces of the door 25 and the front panel 20 so that the door 25 may be opened and closed as described above.

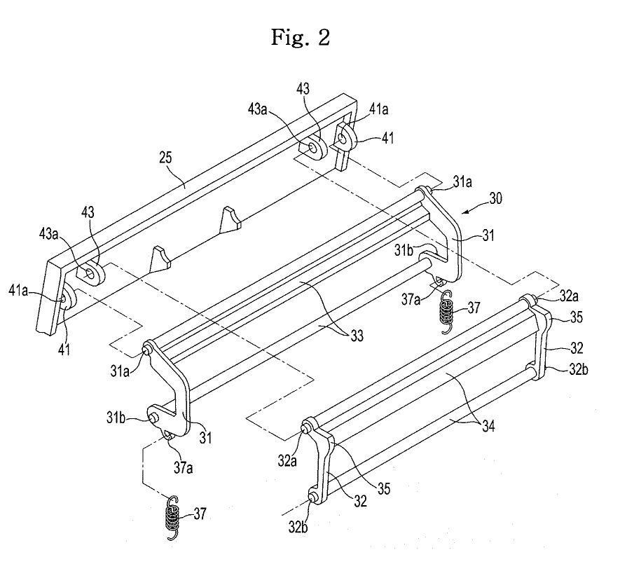

As illustrated in FIGS. 2 and 3, the door connecting unit 30 includes a pair of first connecting links 31 and a pair of second connecting links 32, each having end portions rotatably coupled to the inner surfaces of the door 25 and the front panel 20. The pair of first connecting links 31 and the pair of second connecting links 32 are coupled to the inner surfaces of the door 25 and the front panel 20 by a pair of first shaft coupling parts 41 which are disposed on the inner surface of the door 25, a pair of second shaft coupling parts 42 which are disposed on the inner surface of the front panel 20, a pair of third shaft coupling parts 43 which are disposed slightly above the first shaft coupling parts 41 on the inner surface of the door 25, and a pair of fourth shaft coupling parts 44 disposed slightly above the pair of second shaft coupling parts 42 on the inner surface of the front panel 20.

The pair of second shaft coupling parts 42 and the pair of fourth shaft coupling parts 44 are disposed below the entrance 21 of the optical disc player on the inner surface of the front panel 20. Shaft coupling holes 41a, 42a, 43a and 44a are respectively formed in the first, second, third and fourth shaft coupling parts 41, 42, 43 and 44 to couple the pair of first connecting links 31 and the pair of second connecting links 32 to the first, second, third, and fourth shaft coupling parts 41, 42, 43 and 44. Rotational shafts 31a, 31b, 32a and 32b are provided at end portions of the pair of first connecting links 31 and the pair of second connecting links 32, respectively.

Each of the first connecting links 31 has one end portion rotatably coupled to each of the first shaft coupling parts 41 of the door 25 and the other end portion rotatably coupled to each of the second shaft coupling parts 42 of the front panel 20. Each of the second connecting links 32 has one end portion rotatably coupled to each of the third shaft coupling parts 43 of the door 25 and the other end portion rotatably coupled to each of the fourth shaft coupling parts 44 of the front panel 20.

As illustrated in FIG. 2, each of the first connecting links 31 are formed having the same shape and disposed at opposing sides of the door 25 and, similarly, the second connecting links 32 are formed having the same shape, also disposed at opposing sides of the door 25 in order to securely connect to each side of the door 25. Further, each of the first shaft coupling parts 41 are formed having the same shape and disposed at opposing sides of the inner surface of the door 25, and each of the third shaft coupling parts 43 are formed having the same shape and disposed at opposing sides of the inner surface of the door 25. Additionally, each of the second shaft coupling parts 42 are formed having the same shape and disposed at opposing sides of the inner surface of the front panel 20, and each of the fourth shaft coupling parts 44 are formed having the same shape and disposed at opposing sides of the inner surface of the front panel 20. Both of the first connecting links 31 are connected with each other by a pair of rod-shaped first stiffening members 33 disposed at an upper and lower position, respectively. Thus, each connecting link 31 is disposed at either end of the stiffening members 33. Also, both of the second connecting links 32 are connected with each other by a pair of rod-shaped second stiffening members 34 that are formed at an upper and lower position, respectively. Thus, since the pair of first connecting links 31 are securely connected with each other by the first stiffening members 33, when the door 25 is opened and closed, the pair of first connecting links 31 are rotated at the same time. Also, the pair of second connecting links 32 are secured in the same fashion as the pair of first of connecting links 31 and consequently may also rotate simultaneously as the door 25 is opened or closed. Thus, both sides of the door 25 can be opened and closed in the same way.

As illustrated in FIGS. 3 and 4, the door 25 can be opened while being moved toward the lower front side of the front surface of the optical disc player and can be closed while being moved in an upward and rearward direction (i.e., back to the original position prior to the tray 11 being ejected from the optical disc player), thereby connecting lines A of the rotational shafts 31a, 31b, 32a and 32b to form a parallelogram. That is, the pair of first connecting links 31 and the pair of second connecting links 32 are connected to form a four-joint link.

In order to open or close the door 25 as described above, the following distances should be maintained: a distance between the rotational shafts 31a and 31b at each of the pair of first connecting links 31 should have an equal distance or spacing between the rotational shafts 32a and 32b at each of the pair of second connecting links 32; and an equal distance or spacing between the shaft coupling holes 41a and 43a that are respectively formed in each of the first shaft coupling parts 41. Additionally, each of the third shaft coupling parts 43 should have an equal distance or spacing between the shaft coupling holes 42a and 44a that are respectively formed in each of the second shaft coupling parts 42 and each of the fourth shaft coupling parts 44. Accordingly, the door 25 can be opened or closed while being moved under such conditions. However, the present general inventive concept is not limited thereto. For instance, by varying a distance between the rotational shafts 31a, 31b, 32a and 32b, the door 25 can be rotated slightly forward or slightly backward. Also, an aesthetically pleasing appearance can be achieved by keeping the rear surface of the door 25 out of a user's sight.

As illustrated in FIG. 2, the pair of first connecting links 31 are bent to have an approximately “C” shape configuration. Accordingly, as illustrated in FIG. 4, even though the pair of second shaft coupling parts 42 are disposed below the entrance 21 of the front panel 20, the door 25 can be opened by rotating only the first connecting links 31. Further, by bending the first connecting links 31, interference between the pair of first connecting links 31 and the lower end of the entrance 21 does not occur while the door 25 is opened. Additionally, since the second connecting links 32 are positioned relatively higher than the first connecting links 31, the second connecting links 32 may be bent slightly less than the first connecting links 31. Alternatively, if the pair of fourth shaft coupling parts 44 are to be lowered, the pair of second connecting links 32 may also be bent to have an approximately “C” shape configuration like the pair of first connecting links 31. In this case, the opening and closing operations can be realized in the same manner.

Contact ribs 35 are disposed at respective upper rear portions of the pair of second connecting links 32 and are pushed when the tray 11 is extracted from the main body 10. That is, the contact ribs 35 are pushed by the tray 11 when the tray 11 comes in contact with the ribs 35, thereby opening the door 25. Further, only the contact ribs 35 are in contact with the tray 11, thereby achieving smooth opening and closing operations of the door 25 and smooth extraction and retraction of the tray 11. Although the contact ribs 35 are disposed at the second connecting links 32 in this embodiment, the contact ribs 35 may alternatively be disposed at the first connecting links 31.

As illustrated in FIG. 3, closing springs 37 are installed at opposing ends of the first connecting links 31 to pull the first connecting links 31 in an inward direction towards the main body 10. Thus, when the tray 11 is retracted into the main body 10, the closing springs 37 pull the first connecting links 31 in an inward direction towards the main body 10, thereby closing the door 25. First hooks 37a are disposed at opposing ends of the respective lower back portions of each of the first connecting links 31, and second hooks 37b are disposed at opposing ends of a lower portion of the front panel 20. Each of the closing springs 37 has one end coupled to each of the first hooks 37a and the other end coupled to each of the second hooks 37b. Although the closing springs 37 are installed at the first connecting links 31 in this embodiment, the closing springs 37 may alternatively be installed at the second connecting links 32 and accordingly realize the same operation as being installed at the first connecting links 31.

Hereinafter, opening and closing operations of the door will be described according to the present general inventive concept.

As illustrated in FIG. 3, when the tray 11 is retracted into the main body 10, the closing springs 37 pull the pair of first connecting links 31, whereby the first connecting links 31 and the second connecting links 32 are rotated at the same time inwardly toward the main body 10. Accordingly, the door 25 is closed while being moved upward, toward a back side of the optical disc player. In this case, since the door 25 is connected to the front panel 20 via the pairs of first and second connecting links 31 and 32, forming a four-joint link, the connection between the door 25 and the front panel 20 is aligned to allow the door 25 to be accurately closed.

As illustrated in FIG. 4, when the tray 11 is extracted from the main body 10, the pair of contact ribs 35 formed on each of the second connecting links 32 are pushed forward by the tray 11. Accordingly, the pair of first connecting links 31 and the pair of second connecting links 32 are rotated at the same time in an outward direction away from the main body 10, whereby the door 25 is smoothly opened while being moved toward a lower front side of the optical disc player. When the door 25 is opened, the pair of closing springs 37 are extended. However, also in this case, the elasticity of the pair of closing springs 37 is supplied to each of the first connecting links 31, thereby maintaining a contact state of the contact ribs 35 of the second connecting links 32 with a lower surface of the tray 11 such that the door 25 can be accurately opened.

The door 25 is opened and moved to a lower surface of the optical disc and/or closed by being moved in an upward and rearward direction, thereby keeping the rear surface of the door 25 out of the user's sight. Therefore, only a front surface of the door 25 is exposed to the user at all times according to the present general inventive concept, thereby presenting an aesthetically pleasing appearance and promoting the beauty thereof.

As described above, in the optical disc player according to embodiments of the present general inventive concept, the door is opened or closed by movements via the operations of the pairs of first and second connecting links, thereby keeping the rear surface of the door out of the user's sight. Therefore, it is possible to present an aesthetically pleasing appearance and promote the beauty thereof.

Further, in the optical disc player according to the present general inventive concept, the door is connected to the front panel via the respective pairs of first and second connecting links forming a four-joint link, whereby the door can be consistently opened or closed.

The present general inventive concept is not limited by the embodiments as discussed above, thus, it would be appreciated by those skilled in the art that changes may be made in without departing from the principles and spirit of the general inventive concept, the scope of which is defined in the appended claims and their equivalents.

What is claimed is:

1. An optical disc player comprising:
a main body including a front panel having an entrance;
a tray disposed at the main body to be extracted from or retracted into the main body through the entrance;
a door to open or close the entrance; and
a door connecting unit to connect the door to the front panel such that the door is opened or closed,
wherein the door connecting unit includes:
a first connecting link having one end rotatably connected to a first position of an inner surface of the door and the other end rotatably connected to a second position of the front panel; and
a second connecting link having one end rotatably connected to a third position located higher than the first position of the inner surface of the door and the other end rotatably connected to a fourth position located higher than the second position of the front panel.

2. The optical disc player according to claim 1, wherein the first connecting link and the second connecting link are respectively connected to the second position and the fourth position below the entrance on an inner surface of the front panel.

3. The optical disc player according to claim 2, wherein at least one of the first connecting link and the second connecting link is bent into a “C” shape to prevent interference with a lower end of the entrance while the door is opened.

4. The optical disc player according to claim 2, wherein at least one of the first connecting link and the second connecting link includes a contact rib to be pushed by the tray when the tray is extracted from the main body.

5. The optical disc player according to claim 1, wherein a distance between the first position and the second position is equal to a distance between the third position and the fourth position.

6. The optical disc player according to claim 1, further comprising:
rotational shafts respectively provided at the first to fourth positions to rotatably connect opposite ends of the first connecting link and the second connecting link with the first to fourth positions.

7. The optical disc player according to claim 1, further comprising:
a closing spring installed at at least one of the first connecting link and the second connecting link to pull the door to be closed when the tray retracts into the main body.

8. The optical disc player according to claim 1, wherein each of the first and second connecting links includes a pair of members respectively disposed at opposing sides of the inner surface of the door, and the door connecting unit includes a first stiffening member to connect the members of the first connecting link disposed at the opposing sides of the door and a second stiffening member to connect the members of the second connecting link disposed at the opposing sides of the door with each other.

9. An optical disc player comprising:
a main body including a front panel having an entrance;
a tray installed at the main body to be extracted from or retracted into the main body through the entrance;
a door to open or close the entrance; and
a door connecting unit to connect the door to the front panel such that the door is opened and closed,
wherein the door connecting unit includes a first connecting link and a second connecting link to form a four-joint link, each link having opposite ends rotatably connected to the door and an inner surface of the front panel such that the door is opened or closed by a movement.

10. An optical disc player having a moveable door to secure an entrance formed in a front panel of the optical disc player, comprising:
a first arc shaped door connecting unit having a first end rotatably coupled to an inner surface of the door and a second end rotatably coupled to an inner surface of the front panel such that the door connecting unit rotates in a first direction to move the door to a first position shifted from the entrance and rotates in a second direction to move the door to a second position to a side covering the entrance.

11. The optical disc player of claim 10, further comprising:
a second arc shaped door connecting unit located above the first door connecting unit and having a first end rotatably coupled to an inner surface of the door and a second end rotatably coupled to an inner surface of the front panel.

12. The optical disc player of claim 11, wherein at least one of the first door connecting unit and the second door connecting unit comprise:
a pair of protrusions extending from a rear surface thereof to contact a tray unit as the tray unit is extracted from the main body of the optical disc player.

13. An optical disc player having a front panel including a main entrance formed thereon comprising:
a tray unit to reciprocatingly move in a linear direction from the main entrance of the optical disc player; and
an adjustable door unit being coupled to the front panel and to rotate in a non-linear direction via the reciprocating movement of the tray unit.

14. The optical disc player of claim 13, wherein the door unit comprises:
a door to secure the entrance of the optical disc player;
a pair of first connecting links being separated by a first stiffening member; and
a pair of second connecting links being separated by a second stiffening member,
wherein the first pair of connecting links and the second pair of connecting links simultaneously rotate about a pair of first rotational shafts and a pair of second rotational shafts, respectively.

15. The optical disc player of claim 14, wherein the first pair of rotational shafts are located at opposing ends of the pair of first connecting links and the second pair of rotational shafts are located at opposing ends of the pair of second connecting links.
